(19) United States
(12) Patent Application Publication
(10) Pub. No.: US 2012/0246458 A1
(43) Pub. Date: Sep. 27, 2012

(54) POWER OPTIMIZATION ON A THIN CLIENT DEVICE

(75) Inventors: Vipul K. Jain, San Jose, CA (US); Bhaskar Peddinti, San Ramon, CA (US); James Molenda, Los Gatos, CA (US)

(73) Assignee: CISCO TECHNOLOGY, INC., San Jose, CA (US)

(21) Appl. No.: 13/071,622

(22) Filed: Mar. 25, 2011

(51) Int. Cl. G06F 1/32; G06F 1/24

(52) U.S. Cl. 713/100

(57) ABSTRACT

Power allocated to a plurality of external ports of a thin client device is optimized based on power available to the thin client device that interoperates with a host device. A determination is made as to available power for the thin client device. Operational states of a plurality of external ports of the thin client device are configured based on the available power and operational settings for the thin client device. These operational settings could be user or administrator configured, pre-configured into the thin client device, or a combination thereof.

### TECHNICAL FIELD

The present disclosure relates to power management for thin or “zero” client devices.

### BACKGROUND

In virtualized computing environments, “thin client” devices are used to exploit the processing resources of another device, called a server device. The term “thin client” is used herein to include “zero client” devices (also known as “ultra thin client” devices) which are devices that do not run an operating system but handle display or some other presentation of the server's output.

A thin client device can have minimal processing capabilities and thus be lower cost or have other advantages. One of the challenges for thin client devices which are powered by Power over Ethernet (PoE) technology is to allocate power for the capabilities of the device based on the amount of power available to it. Currently, thin client devices are either completely non-operational when a minimum required amount of power is not available from the power source such as a PoE switch, or a lower power mode must used in order to account for a reduced amount of available power.

### BRIEF DESCRIPTION OF THE DRAWINGS

FIG. 1 is a block diagram showing an example of a system comprising a host device and a thin client device, in which a power optimization scheme is employed for external ports on the thin client device.

FIG. 2 is a block diagram showing an example of a controller that is configured to perform the power optimization scheme.

FIGS. 3-5 are block diagrams showing examples of power switches used in association with the external ports of the thin client device.

FIGS. 6 and 7 are flow charts that depict examples of operations performed by the controller for the power optimization scheme.

FIG. 8 is a diagram showing an example scenario for the power optimization scheme.

FIG. 9 illustrates a flow chart that depicts examples of operations performed during run-time to discover the power profile of external devices connected to a port of the thin client device and subsequently manage the power optimization.

### DESCRIPTION OF EXAMPLE EMBODIMENTS

### Overview

Techniques are provided to optimize power allocated to a plurality of external ports on a thin client device that interoperates with a host device. A determination is made as to available power for the thin client device. Operational states of a plurality of external ports of the thin client device are configured based on the available power and operational settings for the thin client device.

### Example Embodiments

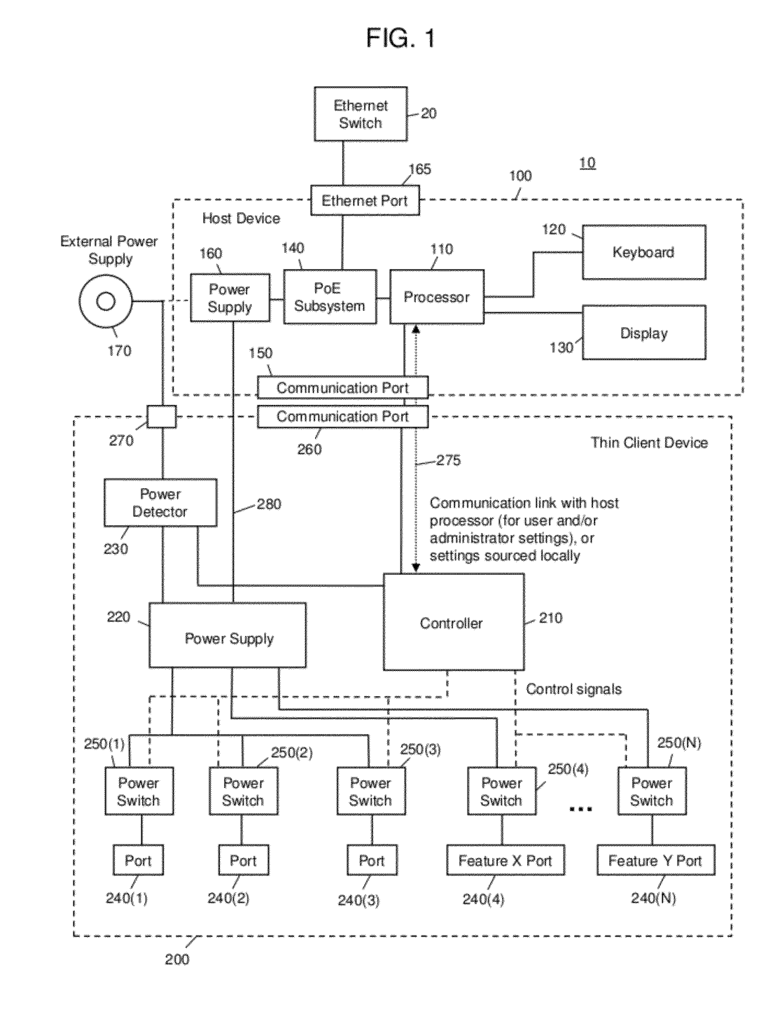

Reference is first made to FIG. 1. FIG. 1 shows a host device-thin client device system or apparatus 10 that comprises a host device 100 and a thin client device 200. The host device 100 and the thin client device 200 may also be viewed as logical entities in that they may both be implemented inside the same physical device (or enclosure) or they may be implemented separately as in the case of a thin client connected as an accessory to another communication device, depending upon the product. Again, the term “thin client” is used herein to include “zero client” devices that, for example, do not run an operating system.

In one example, the host device 100 is an Internet Protocol (IP) phone, desktop computer, laptop computer, etc., and the thin client device 200 is a device that is attached to a desktop IP Phone device, such as a Cisco 8900 or 9900 Series IP Phone. The IP phone supports PoE while the thin client device supports connectivity with monitors, and Universal Serial Bus (USB) ports for connecting a mouse and a keyboard as appropriate for a virtual desktop environment. Another example of a thin client device is a stand-alone device that provides users with access to a virtual desktop and business applications running in a virtualized desktop environment, powered via PoE or an optional power supply, and equipped with multiple USB ports and one or more video output ports to support the appropriate peripherals for a virtual desktop environment.

The host device 100 comprises a processor 110, a keyboard (keypad) 120 that may be optional on some host devices, a display 130 (also optional on some host devices), a Power over Ethernet (PoE) subsystem 140, at least one communication port 150, a power supply and an Ethernet port 165. For example, the communication port 150 is a serial port, such as a USB port, an Ethernet port or any other serial or parallel communication bus port. In one implementation, the communication port 150 is a port with a 1-wire bus. There is also a power supply 160 in the host device 100 that is configured to supply power to the various components of the host device 100 and also to the thin client device 200. In some implementations where the host and thin client are implemented as separate devices, both the host and the thin client may implement a power supply. In implementations where the host and thin client are part of the same device, the power supply may be common. The power supply 160 may receive power from an external power supply device shown at 170 or from the PoE subsystem 140. The host device 100 may comprise other components depending on a particular product implementation. The PoE subsystem 140 negotiates with an Ethernet switch 20 in a network for PoE power to the system 10.

The thin client device 200 comprises a controller 210, a power supply 220, a power detector 230 if there is an option to directly connect an external power supply, a plurality of external ports 240(1)-240(N), a corresponding plurality of power switches 250(1)-250(N) and a communication port 260. The controller 210 serves as the control point for the power optimization on the thin client device 200. The thin client device 200 may incorporate other components depending upon a product implementation and other features required.

The power supply 220 distributes power at the appropriate levels and voltages to the various components in the thin client device 200. One source of power for the thin client device is the external power supply 170 connected to port 270. Another source of power is power from the power supply 160 of the host device 100, which itself may be derived from the external power supply 170 or from the PoE subsystem 140, and supplied over link 280. The power detector 230 detects when an external power supply, e.g., power supply 170, is connected to the thin client device, and supplies an appropriate signal to the controller 210 by way of the connection between the controller 210 and the power detector 230. Still another variation is for the thin client device 200 to obtain PoE power directly from an Ethernet switch, in which case, the thin client device 200 would have a PoE subsystem component and an Ethernet port similar to that in the host device 100. This is similar to the implementation where the host and the thin client are implemented as part of the same physical device.

While the processor 110 and controller 210 are shown as separate logical entities, it should be understood that the same processor, e.g., processor 110, may be used to run the host device 100 and perform the power optimization operations of the controller 210 described herein.

Some of the plurality of external ports 240(1)-240(N) are ports to various communication busses, such as a USB, Peripheral Communication Interface (PCI), Small Computer Serial Interface (SCSI), etc. In addition, some of the external ports are ports to various external components such as display devices, audio devices, etc., and these ports are generically identified as “Feature X” and “Feature Y” ports in FIG. 1. Each of the external ports 240(1)-240(N) has certain operational power settings, and depending on the port, can be configured to operate in various power modes, e.g., low power modes, as well as being completely disabled or enabled (normal power mode).

The power switches 250(1)-250(N) are switches that are configured to supply a suitable power level to an associated port when that port is to be powered on or operated in a low power mode, and to disconnect power from that port when it is to be powered off. Each power switch 250(1)-250(N) is responsive to a control signal from the controller 210 to control the operational state of the associated port, i.e., power on, power off, or one or more low power states/modes.

According to the techniques described herein, the controller 210 automatically configures the external ports 240(1)-240(N) to their maximum possible usability based on available power to the thin client device 200. For example, the controller 210 is configured to select a power profile based on the total power available to the thin client device 200. Different profiles may selectively enable/disable external ports or operate them in a low power mode in order to define separate power envelopes. The controller 210 determines available power and generates control signals that are supplied to the plurality of power switches 250(1)-250(N) to configure operational states of the plurality of external ports 240(1)-240(N) based on the available power and user or administrator operational settings (policies or rules for power allocation priorities for external ports) of the thin client device.

The communication link 275 between the communication ports 150 and 260 serves as an administrator interface through which the host device 100 supplies information, such as the amount of power available to this system, as well as user preference or administrator operational settings for the thin client device 100 depending upon the specific product. For example, a user may use the keyboard 120 to enter the user preference or administrator operational settings and the processor 110 supplies them to the controller 210 in response to request from the controller 210, or after they are entered into the host device 100. In another example, as described hereinafter, the user preference or administrator operational settings are pre-stored in the controller 210 of the thin client device 200.

The controller 210 determines available power to the thin client device 200. When an external power supply is connected to the thin client device, the power detector 220 detects the external power supply and sends a signal to the controller 210 indicating to the controller 210 that power is from the external power supply. The controller 210 is pre-programmed or configured to know the amount of power associated with the external power supply for use when it receives such a signal from the power detector 220, or the amount of power associated with the external power supply could be provided within the administrator or user settings. When power to the thin client device 200 is supplied from the host device 100, then controller 210 communicates, via the communication link 275, with the processor 110 or PoE subsystem 140 of the host device 100 to determine how much power is available to the thin client device 200 from the host device 100. When power for the thin client device 200 is sourced from the host device 100, the power is coupled from the power supply 160 over the link 280 to the power supply 220 in the thin client device. If the thin client device 200 is configured to obtain PoE power directly (not through the host), then the PoE subsystem component in the thin client device 200 would negotiate with an Ethernet switch for power and the PoE subsystem component would supply that information to the controller 210. In still another example, the host device 100 supplies power to the thin client device 200 by way of a USB port, e.g., ports 150 and 260 are USB ports and the power supply 220 supplies power to port 150.

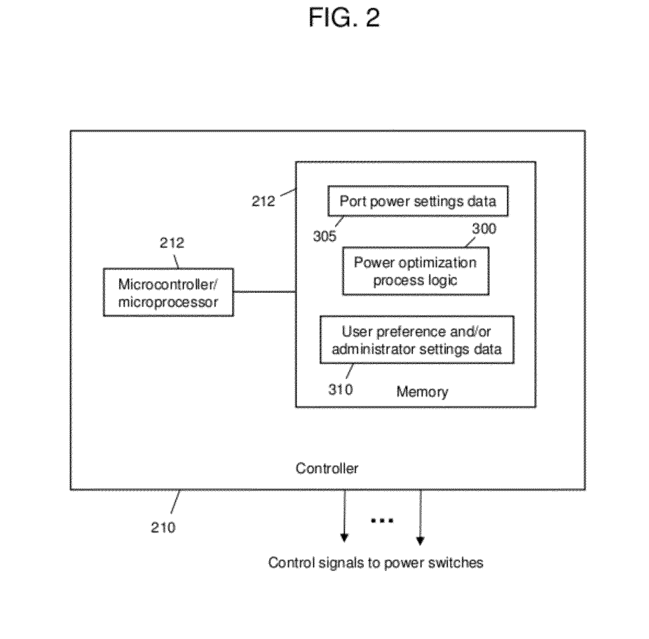

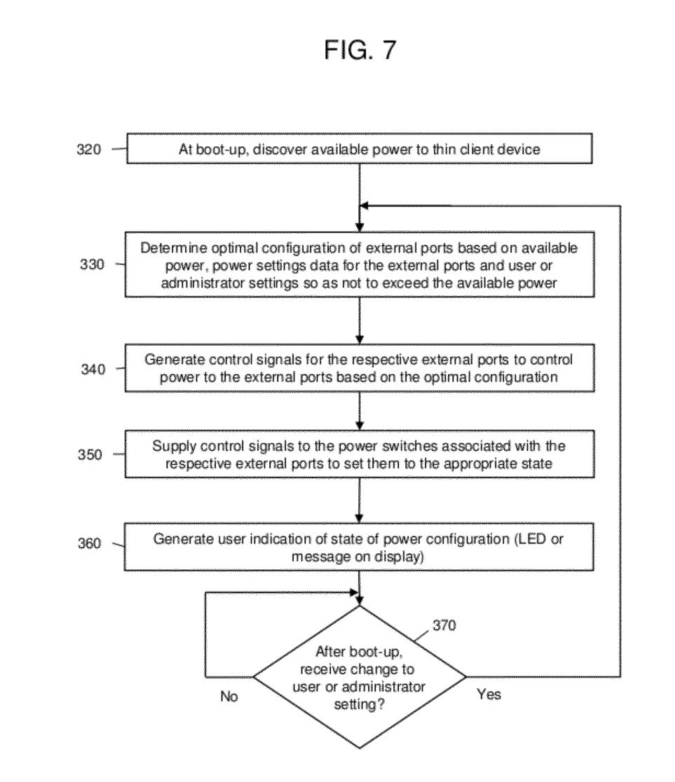

Reference is now made to FIG. 2 for a description of the controller 210. The controller 210 may be implemented in hardware, e.g., digital logic gates in one or more application specific integrated circuits, or by a programmable processor. FIG. 2 illustrates an implementation with a programmable processor, that is, microcontroller/microprocessor 212. Memory 214 is provided that stores instructions executed by the microcontroller/microprocessor 212 to perform various operations of the controller 210, as well as other data used in the course of these operations. For example, the memory 214 stores instructions for power optimization process logic 300 that the microcontroller/microprocessor 212 executes. Operations of the power optimization process logic 300 are described hereinafter in connection with FIG. 7. Also stored in memory 214 are port power settings data 305 that describes the various power configuration settings that are possible for each of the plurality of external ports 240(1)-240(N) and user preference and administrator data 310. The user preference and administrator data 310 comprises data either sourced from the host device 100, locally sourced at the thin client device 200, or pre-stored (“hardwired”) in the thin client device 200. The user preference and administrator data 310 includes data that describes priorities as to which external port resources are to have preference over others to support certain features, e.g., display, audio output, etc., over others. Thus, the user preference and administrator data 310 is used when determining how to configure external ports given the available power to the thin client device.

The memory 214 may include read only memory (ROM), random access memory (RAM), magnetic disk storage media devices, optical storage media devices, flash memory devices, electrical, optical, or other physical/tangible memory storage devices. In general, these memory devices comprise one or more computer readable storage media encoded with software comprising computer executable instructions and when the software is executed, the processor that executes that software (e.g., microcontroller/microprocessor 212) is operable to perform the operations described herein for the power optimization process logic 300.

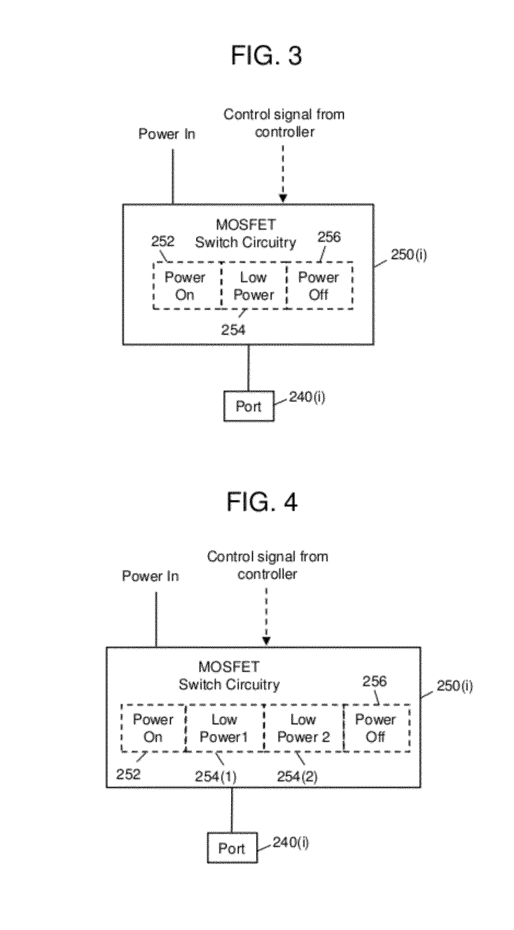

Reference is now made to FIGS. 3-5 that show various configurations of the power switches 250(1)-250(N) shown in FIG. 1. The capabilities of the power switch depend on the type of external port that it is to control. The power switches shown in FIGS. 3-5 are labeled with reference numeral 250(i) to indicate that they may be used for any of the power switches 250(1)-250(N). The power switches shown in FIGS. 3-5 may comprise metal oxide field effect transistor (MOSFET) circuitry configured to provide the states shown. There are numerous configurations of MOSFET circuitry that can be used to achieve these states and one with ordinary skill in the art would know how to make and build such circuitry. Other implementation for the power switches include a suitable integrated circuit switch device, mechanical switches or relays. The power switches receive input power (Power In) from the power supply and are responsive to a control signal from the controller 210 of the thin client device to assume one of its states. The input power to each of the power switches may be different depending on the particular external port associated with a power switch.

FIG. 3 shows a power switch that is configured with three modes or states: Power On (normal power) 252, Low Power 254, and Power Off 256. This type of power switch may be useful for controlling power to an external port that is capable of operating in a low power mode as well as a normal power mode. For example, a USB port may be capable of operating in a low power mode.

FIG. 4 illustrates a power switch similar to that shown in FIG. 3, but having two low power states 254(1) and 254(2). The power switch shown in FIG. 4 is useful for an external port that has multiple different low power operational modes, such as a USB port that is capable of operating in multiple low power states which allow a user to be able to connect devices with different power profiles. For example, Low Power State 1 could only be enabled to provide power sufficient to power a memory stick device while Low Power State 2 may provide additional sufficient power to operate a headset or another device that requires more power than provided by Low Power State 1.

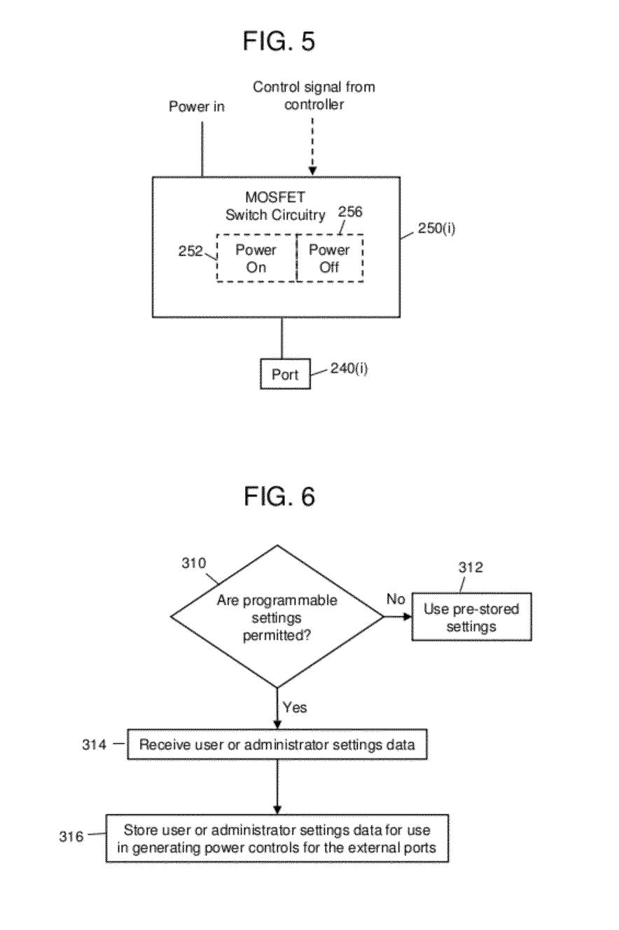

FIG. 5 illustrates yet another power switch that has two states: Power On 252 and Power Off 256. The power switch configuration of FIG. 5 is useful for an external port for a display device.

Reference is now made to FIGS. 6 and 7 for a description of the operations of the power optimization process logic 300. FIG. 6 shows a flow chart for determining the source of user or administrator settings to use for the power control techniques described herein. At 310, a determination is made as to whether use of programmable user or administrator settings is permitted or whether pre-stored settings are to be used. The thin client device can be configured to either allow for programmable settings or to use the pre-stored settings. When configured to use pre-stored settings, then operation 312 is performed to use the pre-stored settings. Otherwise, at 314, the thin client device can receive settings input either from the host device or at the thin client device. At 316, the settings data is stored in the controller of the thin client device and used for generating power controls for the external ports.

The operations depicted in FIG. 6 may be performed at initial boot-up and prior to the actual power allocation analysis used to control power to the various external ports. If the thin client device is configured to permit programming of the settings, input for those settings can be received at any time after boot-up, as explained further hereinafter in connection with FIG. 7.

As explained above, the user or administrator settings data is used by the power optimization process to determine whether certain ports or features of the thin client device are to have priority over others in order to allocate power to the higher priority ports or features before allocating power to the lower priority ports or features. Thus, the optimal configuration is based on data representing operational settings that indicate relative priority for operation of one or more of the plurality of external ports. In addition, the user or administrator settings data can indicate whether a low power mode for a particular port is to be permitted. For example, the settings may be made so that a particular port can only be operated in a normal state if sufficient power is available even if that port has a low power state if sufficient power is not available to support the normal state. Conversely, the settings data may be configured such that all lower power states for a port are to be considered when allocating power across the ports. The settings data may be specific to individual ports and/or have a set of policies or rules that are to be applied across all ports.

In allowing a user to input operational settings, the controller 210 may generate a menu for presentation to a user. The menu may present options as to which ports to power and at which power level (normal power or low power) for each port, which ports are to be given priority over other ports. Alternatively, the menu may allow a user to select default or pre-configured power profiles.

Reference is now made to FIG. 7 for a description of the power analysis and control aspects of the power optimization process logic 300. Reference is also made to FIGS. 1 and 2 for purposes of this description. At 320, during boot-up of the system, controller 210 discovers the power available to the system after communicating with the processor 110 and/or a PoE component, e.g., the PoE subsystem 140 in the host device 100, or by the power detector 230 detecting an external power supply.

At 330, an optimal power configuration for the external ports is determined based on the available power, the port power settings data 305 and the user or administrator settings data 310, so as not to exceed the available power. The optimal power configuration may involve shutting down some of the features of the thin client device 200 that may be deemed “core” functions. At certain times, these “core” functions may not be necessary and can be shut down in favor of operation of one or more external ports. The port power settings data 305 is used as a reference as to the power requirements/capabilities of a given port, that is, how much power that port requires in its one or more operational modes.

At 340, control signals for the power switches for the external ports are generated to control power to the external ports based on the optimal configuration determined at 330. At 350, the control signals generated at 340 are supplied to the power switches associated with the respective external ports to set the power switches to the appropriate states, and in so doing, control the operational states of the external ports, e.g., Power On, Power Off, Low Power Mode, Low Power Mode 1, Low Power Mode 2, etc.

At 360, a user indication of state of power configuration is generated. For example, the user indication consists of illumination of a light emitting diode (LED) on the thin client device 200 or display of a message, icon or other visual indication on a display device. The illumination of the LED or other visual display may be made to indicate that a low power mode is being used.

At 370, changes can be made to the user or administrator settings by way of input from the host device or thin client device. If such changes are made, then operations 330-360 are repeated with the updated settings to reconfigure the external ports. Thus, as depicted by the flow chart in FIG. 7, configuration of the external ports can be initiated during operation (post boot-up) of the system by an external entity, for example by writing a value through the administrator interface.

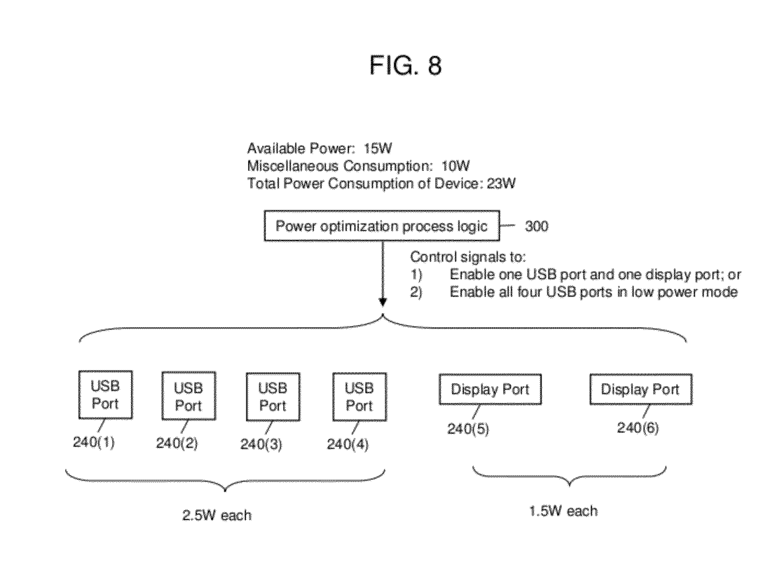

FIG. 8 shows an example for operation of the power optimization process logic 300. A system implementing a thin client remote desktop appliance has 4 USB ports 240(1)-240(4) and 2 external display ports 240(5) and 240(6). Each USB port could consume as much as 2.5 Watts (W) and each display port could consume another 1.5 W each. The controller and miscellaneous other circuitry in the remote desktop appliance may consume an addition 10 W. Therefore, when this system is being used in its maximum configuration (both displays connected, all 4 USB ports being used), the total power consumption could be as high as 23 W.

If this system is deriving power from a PoE subsystem of a host device (e.g., an IP phone, that is connected to a PoE switch), the PoE switch may only have 15 W available for the system. The power optimization process logic 300 enables the system to operate in a “less than maximum” mode such that the power consumption can stay within the available power. In this example, the power optimization process logic 300 can choose to enable only one USB port and one external display port to stay within 15 W, or it can configure all 4 USB ports in a low power mode (and disable the external display ports) depending upon user or administrator preferences.

If the techniques described herein were not used for this example scenario, the system would not be able to operate until the full 23 W was available from the PoE switch (or an external power supply). Note that in many cases, a user may not even need all the available power of the system. These techniques optimize the user experience of the system to the maximum possible within the power available by selecting an appropriate power profile for external ports of the system. As a result, the usability of the system is significantly expanded, which is particularly important in a large installation where power availability could be at a premium.

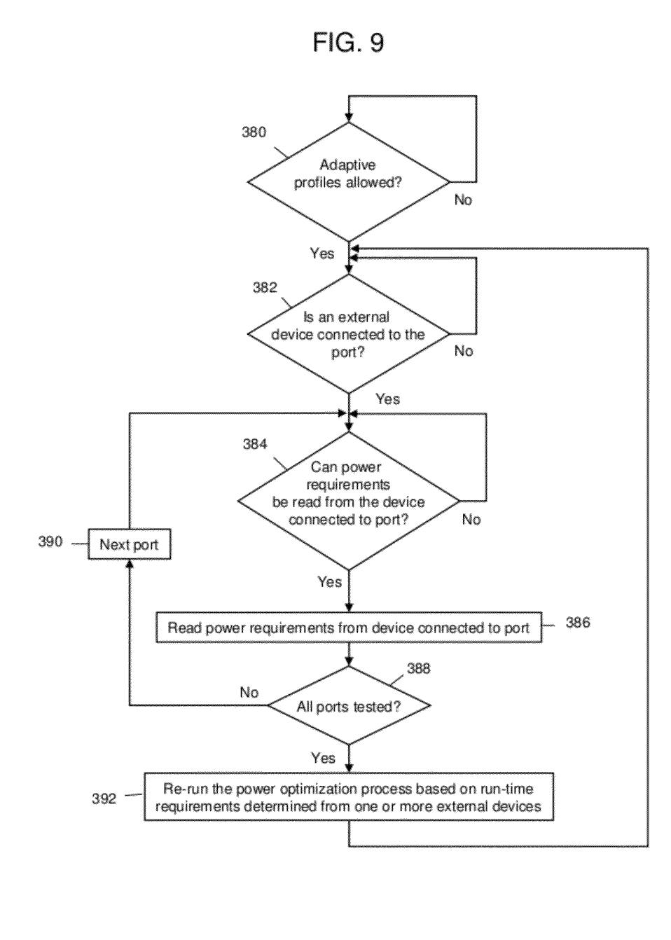

With reference to FIG. 9, a further feature of the power management/optimization techniques is described. The power optimization techniques depicted by FIGS. 7 and 8 are typically run at boot-up of the system and based on pre-configured power requirements of the thin client device, i.e., pre-configured or fixed power requirements of the plurality of external ports. However, during run-time of the thin client device, external devices may be connected to (and disconnected from) one or more of the ports from which it may be possible to read or learn the power requirements of the external devices. For example, many USB devices are able to communicate information indicating their power consumption/requirements during enumeration. The operations shown in the flow chart of FIG. 9 are used by the controller 210 during run-time (after boot-up) of the device to read or learn the power consumption/requirements of an external device connected to one of the external ports of the thin client device 200. At 380, a determination is made as to whether adaptive profiles are permitted in the thin client device to adapt the power optimization based on power requirements learned by the controller 210 for an external device connected to one of the external ports. When an external device is connected to the port, then at 384, it is determined whether the power requirements can be read from the external device connected to that port. For example, a headset device connected to a USB port may require a certain amount of power that is different from that required by a mouse or keyboard. If the particular port in question and the type of device allows for learning the power requirements of the external device at that port, then at 386, the controller 210 of the thin client device, through suitable software driver capability for that port, communicates with the external device and receives information from the external device that indicates the power requirements for the external device at that port. At 388, it is determined whether all of the ports have been tested for an external device, and if not, the next port is evaluated as indicated by operation 390. Thus, the operations 384 and 386 are repeated for all external ports.

At 392, using the power requirements learned for all of the ports (resulting from connection of and communication with external devices connected to the ports) and potential disconnections of external devices from ports, the controller re-runs the power optimization process (as depicted at operations 330-360 in FIG. 7). As a result of this re-running of the power optimization process, assuming sufficient available power, the controller 210 generates a control signal to set the power permitted by the power switch for the external port to which the external device is connected, using the learned power value instead of using the pre-configured power settings available at boot-up for that external port. For example, the power allocation scheme and configuration of ports at boot-up may result in all of the external ports being configured/powered for normal operation based on the available power. However, after a device is connected to one of the external ports and the controller 210 learns the power requirements/consumption for an external device at that external port, it configures power allowable to that external port accordingly, i.e., to a different power setting than its pre-configured power setting. Depending on user or administrative settings if such a feature is implemented on the thin client device, it may also be necessary to downgrade an operation mode of another external port that is not in use, due to the power re-allocated to the active external port where a device is currently connected and requesting more power than its pre-configured setting. Conversely, when an external device is disconnected from a port, more power will be available for usage by other ports, depending on user or administrative settings, etc. The operations depicted in FIG. 9 repeat on a periodic basis or when the controller detects that a device has been connected or disconnected from port. In sum, the operations depicted in FIG. 9 involve determining run-time power requirements of the thin client device by communicating with an external device through an external port to which the external device is connected to receive information indicating the power consumption of the external device at that external port. The controller configures (allowable) power for the external port to which the external device is connected based on the power requirements learned from the information received form the external device. The power optimization determination is adaptively performed based on (real-time, i.e., run-time) power requirements associated with the plurality of external ports.

In sum, the power management system and techniques described herein for a thin client device, e.g., a remote desktop device, control features or ports of the appliance to fit within the available power to maximize user experience within that available power, such as PoE power. These techniques enhance user experience by automatically selecting the best possible profile based on user/administrator preferences and power available. A user does not need to know about the power available to the system; the controller automatically determines available power and configures the system appropriately. The power profile of the system can achieve greater granularity (even adaptively) in controlling the operational states of the external ports to optimize the use of available power.

The above description is intended by way of example only.

What is claimed is:

1. A method comprising:
determining available power for a thin client device that interoperates with a host device; and
configuring operational states of a plurality of external ports of the thin client device based on the available power and operational settings for the thin client device.

2. The method of claim 1, and further comprising receiving power for the thin client device from an external power supply device, and wherein determining available power is based on power from the external power supply device.

3. The method of claim 1, and further comprising receiving power for the thin client device from the host device, and wherein determining available power comprises receiving information from the host device indicating available power to the thin client device.

4. The method of claim 3, wherein receiving information comprises receiving information indicating amount of power available to the thin client device from a Power over Ethernet component.

5. The method of claim 1, wherein configuring comprises generating control signals for respective external ports to configure the external ports to be in one of: a power off state, power on state, or one or more low power states.

6. The method of claim 1, and further comprising determining an optimal configuration for the plurality of external ports based on the available power, power settings for the plurality of external ports and the operational settings, and wherein configuring comprises supplying control signals to power switches associated with respective ones of the plurality of external ports to control the operational states of the plurality of external ports.

7. The method of claim 6, wherein determining the optimal configuration is based on data representing the operational settings that indicate relative priority for operation of one or more of the plurality of external ports.

8. The method of claim 6, and further comprising determining whether data is available in the thin client device for the operational settings, and if not, receiving data for the operational settings from the host device.

9. The method of claim 1, and further comprising receiving information from an external device connected to one of the plurality of external points, the information indicating power requirements of the external device, and wherein configuring comprises configuring power allowable to the external port to which the external device is connected based on the power requirements learned from the information received from the external device.

10. An apparatus comprising:
a plurality of external ports;
a plurality of power switches, each configured to control an operational state of a corresponding external port;
a power supply unit configured to supply power to the plurality of power switches; and
a controller configured to determine available power and generate control signals supplied to the plurality of power switches to configure operational states of the plurality of external ports based on the available power and operational settings.

11. The apparatus of claim 10, and further comprising a port configured to receive power from an external power supply device and a power detector unit configured to detect when the external power supply device is connected, and wherein the controller is configured to determine available power in response to a control signal received from the power detector unit.

12. The apparatus of claim 10, wherein the power supply unit is configured to receive power from a host device, and wherein the controller is configured to determine available power by receiving information from the host device that indicates the available power.

13. The apparatus of claim 12, wherein the controller is configured to determine available power based on information indicating an amount of power available from a Power over Ethernet component.

14. The apparatus of claim 10, wherein the controller is configured to generate control signals for respective external ports to configure the external ports to be in one of: a power off state, power on state, or one or more low power states.

15. The apparatus of claim 10, wherein the controller is configured to determine an optimal configuration for the plurality of external ports based on the available power, stored data indicating power settings for the plurality of external ports and data representing the operational settings, and the controller is configured to supply control signals to power switches associated with respective ones of the plurality of external ports to control the operational states of the plurality of external ports.

16. The apparatus of claim 15, wherein the controller is configured to determine the optimal configuration based on data representing the operational settings that indicate relative priority for operation of one or more of the plurality of external ports.

17. The apparatus of claim 10, wherein the controller is configured to receive information from an external device connected to one of the plurality of external points, the information indicating power requirements of the external device, and to configure power allowable to the external port to which the external device is connected based on the power requirements learned from the information received from the external device.

18. One or more computer readable storage media encoded with software comprising computer executable instructions and when the software is executed operable to:
determine available power for a thin client device that interoperates with a host device; and
generate control signals to configure operational states of a plurality of external ports of the thin client device based on the available power and operational settings for the thin client device.

19. The computer readable storage media of claim 18, wherein the instructions that are operable to determine available power comprise instructions operable to determine available power based on power from an external power supply device.

20. The computer readable storage media of claim 18, wherein the instructions that are operable to determine available power comprise instructions operable to receive information from the host device that indicate available power for the thin client device.

21. The computer readable storage media of claim 18, wherein the instructions that are operable to determine available power comprise instructions operable to receive information indicating an amount of power available from a Power over Ethernet component.

22. The computer readable storage media of claim 18, wherein the instructions that are operable to generate control signals comprise instructions operable to generate control signals for respective external ports to configure the external ports to be in one of: a power off state, power on state, or one or more low power states.

23. The computer readable storage media of claim 18, and further comprising instructions that are operable to determine an optimal configuration for the plurality of external ports based on the available power, power settings for the plurality of external ports and the operational settings, and further comprising instructions that are operable to supply the control signals to power switches associated with respective ones of the plurality of external ports to control the operational states of the plurality of external ports.

24. The computer readable storage media of claim 23, wherein the instructions that are operable to determine the optimal configuration are based on data representing the operational settings indicating relative priority for operation of one or more of the plurality of external ports.

25. The computer readable storage media of claim 18, and further comprising instructions that are operable to receiving information from an external device connected to one of the plurality of external points, the information indicating power requirements of the external device, and to configure power allowable to the external port to which the external device is connected based on the power requirements learned from the information received from the external device.
